(19) United States
(12) Patent Application Publication
(10) Pub. No.: US 2009/0157540 A1
(43) Pub. Date: Jun. 18, 2009

(54) DESTINATION AUCTIONED THROUGH BUSINESS OF INTEREST

(75) Inventors: Neil W. Black, Seattle, WA (US); Ruston Panabaker, Redmond, WA (US); John C. Krumm, Redmond, WA (US); Jeffrey D. Couckuyt, Bothell, WA (US); Ivan J. Tashev, Kirkland, WA (US); Michael Lewis Seltzer, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/957,139

(22) Filed: Dec. 14, 2007

(51) Int. Cl. G06Q 40/00

(52) U.S. Cl. 705/37

(57) ABSTRACT

In order to provide advertising to a user concerning an intended travel destination, an auction takes place where multiple companies place bids to have an advertisement disclosed. Bid selection can take place according to various parameters, including matching a user interest, a bidder that offers a highest price, etc. Bids can be solicited and then received—once a bid is selected for presentation, the advertisement can be received, evaluated, and then presented to a user.

### CROSS-REFERENCE

This application relates to U.S. Patent Application draft with Attorney Docket No. MSFTP2086US entitled “ROUTE MONETIZATION”.

This application relates to U.S. Patent Application draft with Attorney Docket No. MSFTP2087US entitled “FEDERATED ROUTE PRODUCTION”.

This application relates to U.S. Patent Application draft with Attorney Docket No. MSFTP2089US entitled “GENERATIONAL INTELLIGENT NAVIGATION MANIPULATION”.

This application relates to U.S. Patent Application draft with Attorney Docket No. MSFTP2090US entitled “SOCIAL NETWORK BASED ROUTES”.

This application relates to U.S. Patent Application draft with Attorney Docket No. MSFTP2091US entitled “ROUTE TRANSFER BETWEEN DEVICES”.

This application relates to U.S. Patent Application draft with Attorney Docket No. MSFTP2092US entitled “ADDITIONAL CONTENT BASED ON INTENDED TRAVEL DESTINATION”.

This application relates to U.S. Patent Application draft with Attorney Docket No. MSFTP2093US entitled “AUTOMATIC SPLICES FOR TARGETED ADVERTISEMENTS”.

This application relates to U.S. Patent Application draft with Attorney Docket No. MSFTP2094US entitled “PEDESTRIAN ROUTE PRODUCTION”.

This application relates to U.S. Patent Application draft with Attorney Docket No. MSFTP2095US entitled “ROUTE GENERATION BASED UPON ACTIVITY CRITERIA”.

### TECHNICAL FIELD

The subject specification relates generally to traffic routing and in particular to providing added content based on an intended destination.

### BACKGROUND

Computer technology allows for a wide range of functionality that can be used when traveling in a vehicle. Many users place a road atlas in a vehicle that enables the user to plan a route manually. When manually planning a route, a user is commonly not privy to real-time information that can be valuable relating to route construction. A road atlas is commonly printed a substantial time before it is sold—new roads can be developed that are not located upon the atlas.

At-home computer route generation allows a user to create directions from a computer by entering information into the computer, such as a date the user intends to travel. A paper copy of the directions can be printed and the user can take the directions with her in the vehicle to follow as she travels. Various amounts of information can be provided through at-home generated directions, such as distance and/or time a vehicle is to spend on a particular road.

An alternative to at-home computer route generation is use of an in-vehicle navigation system. Navigation systems allow an operator to travel along a planned route and receive ‘turn-by-turn’ instructions as she reaches an area where an instruction could be helpful. Commonly, a user enters a starting point or obtains it through a global positioning system, at least one destination, and constraints upon which a route should be constructed. For instance, if a user is a relatively new driver with little driving experience, then she can request that a route be constructed that avoids highways.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

Conventionally, a user travels to an intended destination by following a generated route with little information concerning the destination. The user knows of an address and possibly some contextual information, such as anticipated traffic density based on a time of day. There are several disadvantages in conventional route destination disclosure. If a user is unfamiliar with an area, then she can miss numerous opportunities for enjoyment since she is focusing on not becoming lost, such as stopping for something to eat at a nearby diner. Even if the user has a large appreciation of an intended destination area, she can still miss details to enhance a travel experience due to concentration of resources on driving (e.g., viewing scenery).

The disclosed innovation operates an auction process where different parties (e.g., advertisers) submit bids to have a detail (e.g., advertisement) disclosed to a user. An exchange component engages various entities and obtains bids to disclose information to a user from the entities. A choice component analyzes the bids and makes a selection based upon the analysis—for instance, a bid can be selected that offered a highest monetary amount for disclosure. The information can be disclosed to the user and a fiscal transaction can take place in relation to the disclosure, such as debiting an advertiser account and crediting a user account or hosting service for presentment of the information.

Conventional auctions, such as timed data network auctions (e.g., Internet auctions) take place over long stretches of time and are relatively open-ended (e.g., any bidder with an account can place a bid and the bid has a chance of being fraudulent, where a highest bidder has no intention of paying). Application of classical auctions upon intended destination information disclosure would not seem reasonable due to the large amount of possible congestion, since bids could reach into the billions and processing would be cumbersome. The subject innovation commonly produces limited auctions, where bidding parties have an interest in an intended destination, such as parties having a business within a particular radius. Success of limited auctions disclosed by the subject innovation is an unexpected result—conventional auctions typically have no bidders on many items, so it seems unlikely that having a limited auction would produce enough successful auctions to make practice reasonable. However, since bidders have a strong interest in placing a proposal (e.g., since bidders are tied to a destination they know with relative certainty a user will arrive at), limited auctions become unexpectedly successful.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative bidding system in accordance with an aspect of the subject specification.

FIG. 2 illustrates a representative exchange component in accordance with an aspect of the subject specification.

FIG. 3 illustrates a representative choice component in accordance with an aspect of the subject specification.

FIG. 4 illustrates a representative bidding engagement configuration in accordance with an aspect of the subject specification.

FIG. 5 illustrates a representative vehicle with a bidding system and multi-portion disclosure component in accordance with an aspect of the subject specification.

FIG. 6 illustrates a representative bidding system with a generation component and transaction component configuration in accordance with an aspect of the subject specification.

FIG. 7 illustrates a representative bidding methodology in accordance with an aspect of the subject specification.

FIG. 8 illustrates a representative bid selection methodology in accordance with an aspect of the subject specification.

FIG. 9 illustrates a representative bid disclosure methodology in accordance with an aspect of the subject specification.

FIG. 10 illustrates an example of a schematic block diagram of a computing environment in accordance with the subject specification.

FIG. 11 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

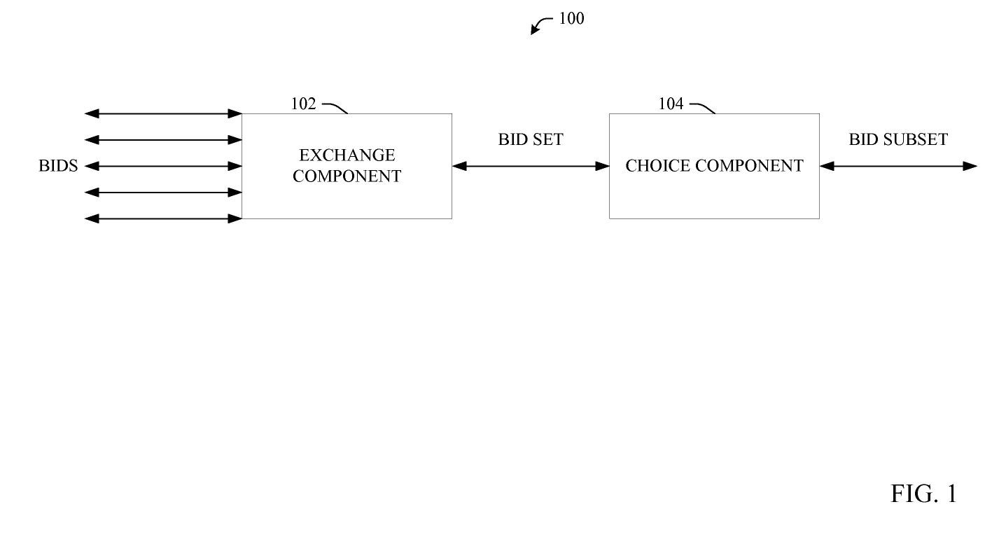

FIG. 1 discloses an example system 100 for operating an auction to disclose a detail, such as a commercial detail (e.g., advertisement) related to an intended travel location (e.g., destination, place along a route, start point, etc.). When a user travels to an intended location, there can be an opportunity to present a detail to the user that relates to the intended destination. However, there can be a large number of possible details for presentment—in order to be effective, a limited detail subset is presented to the user. In addition, the user can set some limitations on the amount of advertisement she is willing to be subjected to, commonly through audio or visual presentment.

An exchange component 102 engages at least one entity to obtain a bid set that corresponds to a set of details related to an intended travel location of a user. The exchange component 102 can actively communicate with entities in order to obtain bids to disclose a detail (e.g., an advertisement) to a user. For instance, different companies can have systems dedicated to making bids for advertisement disclosure in relation to an intended travel location. The exchange component 102 can perform a search upon an intended location to ascertain relevant contextual information. In an example, the exchange component 102 can search within about a half-mile radius of an intended destination for companies capable of bidding for advertisement presentment. The exchange component 102 can correspond to capable companies asking for a bid submission and bids can be communicated accordingly.

A bid set (e.g., about one or more bids) can transfer to a choice component 104 at one time, as bids are obtained, etc. The choice component 104 selects a bid subset (e.g., whole or part of the bid set), selection of the bid subset enables a detail subset to be presented to the user. The choice component 104 can facilitate an auction, where at least one bid is selected over at least one other bid. The selection is commonly based upon financial reward offered for selection of the bid subset, an obligation, a characteristic of a bidder, a characteristic of the user, or a combination thereof. The choice component 104 can select a bid subset that presents information to a group of individuals. For instance, an auction can be facilitated that presents a popcorn advertisement to users traveling to a movie theater on a particular day. When a reward is paid by a successful bidder, a company running the system can be paid an amount of reward to disclose an advertisement and/or a user can be paid an amount of reward. A company running the system 100 can have a contractual obligation to disclose several advertisements and the choice component 104 selects a bid to assist in meeting the obligation. According to one embodiment, a selected bid can include exclusive placement where competitor information is not disclosed to a user or no other information is disclosed to a user. For instance, as part of a winning bid for Company A, information for Company A can be disclosed and no information for Company B can be disclosed (e.g., within a time window, during a travel duration, until an action takes place such as a user stopping to purchase food, etc.).

Moreover, characteristics of a bidder and/or user can be taken into account. A bidder that is more reputable can have a bid selected over other bidders with more questionable reputations. In addition, a user can have personal characteristics that become important in bid selection. If the user has an allergy to peanuts, then the choice component 104 can reject a bid to disclose a peanut butter advertisement. Example user characteristics can include how tolerable a user is to being subjected to advertisements (e.g., used to limit number of advertisements), user interests (e.g., a user is more likely to appreciated advertisements on topics she enjoys), how often a user can listen to an advertisement replay multiple times, etc.

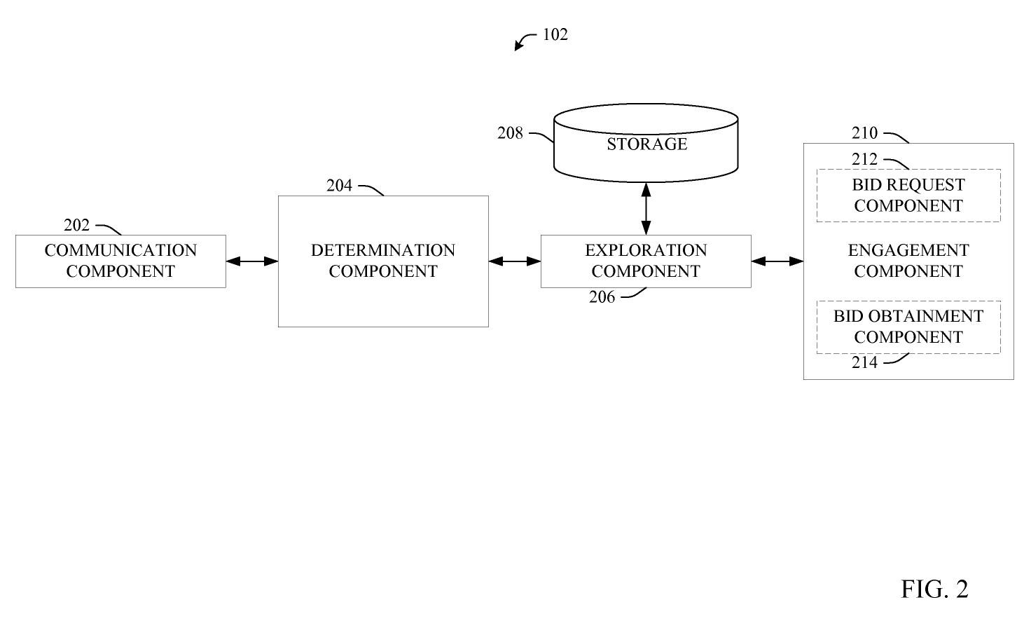

FIG. 2 discloses an example exchange component 102 that can operate in the system 100 of FIG. 1. A communication component 202 can engage with other devices to transfer information. Operation can take place wirelessly, in a hard-wired manner, employment of security technology (e.g., encryption), etc. Moreover, the communication component 202 can utilize various protective features, such as performing a virus scan on obtained data and blocking information that is positive for a virus.

The communication component 202 can obtain bid data and transfer the data to a determination component 204 that resolves bid types that are to be located by the exchange component 104. In a densely populated metropolitan area, there can be a relatively large number of bid suppliers. Some bids would be irrelevant, inappropriate, etc. and the determination component 204 can prevent the exchange component 102 from obtaining these bids. For instance, a sixteen-year old driving an automobile to a mall would not be admitted to a tavern requiring attendees to be at least eighteen years of age—a bid requesting to advertise for the tavern would be irrelevant since the tavern cannot be entered by the driver. The determination component 204 can send information that bids relating to the tavern should not be obtained. The determination component 204 can function as a means for determining location types that are to produce the set of bids.

An exploration component 206 can locate entities that produce bid submissions, commonly in accordance with limitations discovered by the determination component 204. A common entity type is a computer system that automatically produces bids; the exploration component 206 can locate a computer system through an Internet Protocol address. The exploration component 206 can utilize storage 208 to hold known addresses, upon which addresses can be extracted when beneficial. For example, a nation-wide fast food chain can have a central database that produces bids; the exploration component 206 would locate the central database, not an individual restaurant near an intended location. As opposed to performing a new search when a restaurant is near an intended location, the exploration component 206 can access the central database address from the storage 208. The exploration component 206 can operate as a means for locating entities, located entities are engaged for bid obtainment.

Storage 208 can arrange in a number of different configurations. Example configurations include random access memory, battery-backed memory, hard disk drive, magnetic tape, etc. Various features can be implemented upon storage, such as compression and automatic back up (e.g., use of a Redundant Array of Independent Drives configuration). A personal profile of a user can be held upon storage 208 and the storage 208 can include logic to update the profile based upon learned history.

An engagement component 210 interacts with an entity location in order to procure a bid submission. A bid request component 212 sends an application to an entity to produce a bid to disclose a detail to a user. The application can include parameters for the bid or parameters for the detail disclosed. In addition, contextual information can be disclosed to the entity that enables the entity to determine if a bid should be placed (e.g., through use of artificial intelligence techniques).

A bid obtainment component 214 gathers bids submitted by entities, commonly from entities that received an application. In addition to gathering bids, the bid obtainment component 214 can perform extraction of information related to the bids. For instance, extraction information includes contents of a detail associated with the bid, a price offered for disclosing the detail, etc. Extracted information as well as other content collected by the engagement component 210 can transfer to the choice component 104 of FIG. 1.

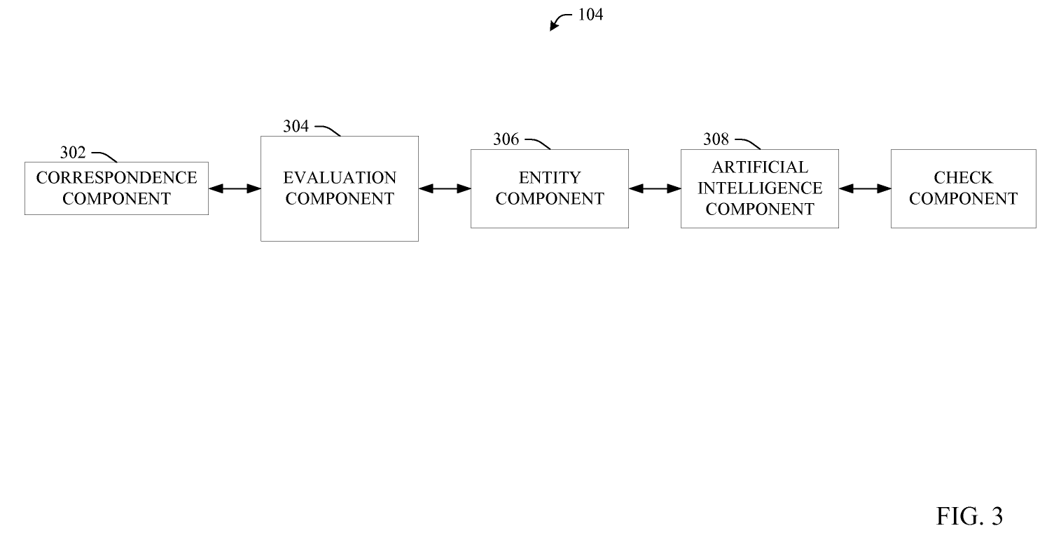

FIG. 3 discloses an example choice component 104 that can operate in the system 100 of FIG. 1. A correspondence component 302 can engage with other devices to transfer information. Operation can take place wirelessly, in a hard-wired manner, employment of security technology (e.g., encryption), etc. Moreover, the correspondence component 302 can utilize various protective features, such as performing a virus scan on obtained data and blocking information that is positive for a virus.

An evaluation component 304 analyzes a bid set (e.g., a bid set transferred from the exchange component 102 of FIG. 1), bid subset selection is based at least in part upon analysis of the bid set. Analysis commonly includes comparing bids against one another in addition to comparing bids against known criteria. For example, bids can offer a reward if a detail is disclosed to a user; the evaluation component 304 can compare rewards against one another to determine a highest bidder. While detail information can be known when a bid is obtained, it is to be appreciated that a bid selection can be made without knowing information about the detail.

An entity component 306 determines a number of details that can be disclosed to a user or a number of bids that can be accepted (e.g., determination through artificial intelligence techniques). A user can have an about fifteen-second window to be subjected to advertisements and about four bids can be collected to disclose an about five-second advertisement. Therefore, about three advertisements can be disclosed to the user in the specified time window. The entity component 306 can appreciated that there can be about three advertisement slots available and determine that about three bids should be accepted.

An artificial intelligence component 308 makes at least one inference or at least one determination in relation to bid selection. For example, the artificial intelligence component 308 can compare different bids and determine that a bid offering a highest price should be selected. In addition, the artificial intelligence component 308 can make various inferences relating to bid selection. A user operating a vehicle operating the system 100 of FIG. 1 can have a personal profile that includes operational history held upon storage 208 of FIG. 2. Inferences can be made that based upon user reaction to previous details, a particular detail is likely to be followed by the user (e.g., the user is to visit an advertised establishment) and a particular bid associated with the detail should be accepted.

The artificial intelligence component 308 can employ one of numerous methodologies for learning from data and then drawing inferences and/or making determinations related to applying a service (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. Methods also include methods for the capture of logical relationships such as theorem provers or more heuristic rule-based expert systems.

As different bids are placed, other entities are notified of the bids parameters and are offered to modify bids over an amount of time (e.g., to place a bid offering more money). A check component 310 can accept a bid and verify that an entity related to a bid can perform an obligatory action, such as engaging in a financial transaction. A entity with a winning bid can have an insufficient amount of money in a debit account to pay a fee, have too many outstanding debts (e.g., previous winning bids that have not been paid), does not have a suitable configuration to transmit a detail, etc. If a winning bid supplier is faulty, then the check component 310 can attempt to accept a subsequent bid. In addition, the check component 310 can transfer notices that a bid is not accepted.

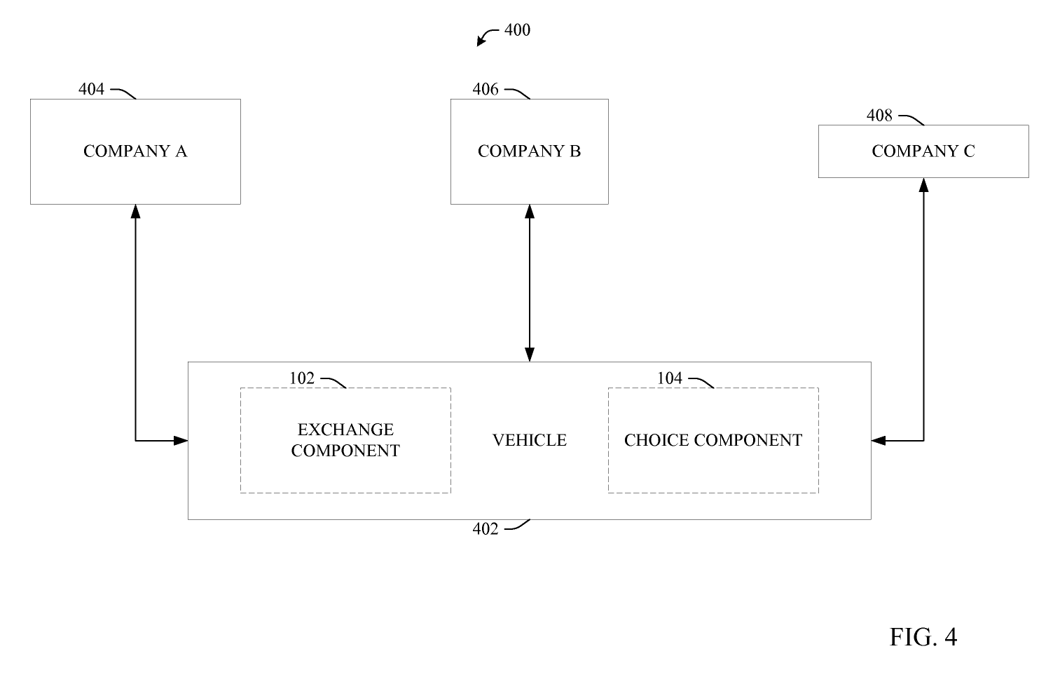

FIG. 4 discloses an example environment 400 for operations disclosed in the subject specification. A vehicle 400 can include an exchange component 102 and a choice component 104 that engage entities in order to conduct a detail disclosure auction. Example vehicles include an automobile, motorcycle, bicycle, airplane, helicopter, motorboat, self-balancing transportation device, etc. While disclosed in the vehicle 400, it is to be appreciated that the exchange component 102 and/or the choice component 104 can operate outside of the vehicle—they can operate in a remote location and a bid subset can be transferred to a mobile device, such as a personal digital assistant. In addition, aspects of the subject specification do not have to operate with a vehicle, the user can be walking and a detail is disclosed over a personal digital assistant that includes the exchange component 102 or the choice component 104.

An auction can be operated where entities place static bids—a bid is placed and evaluation/selection takes place upon the bid without an opportunity for counter-bids. This allows for faster processing and dedication of fewer resources since auctions can be completed in a quicker amount of time. Different companies can be engaged by the exchange component 102 in order to solicit bids to disclose an advertisement to a user.

In an illustrated example, there are three entities: Company A 404, Company B 406, and Company C 408. The companies can have a coffee shop within a three-block radius of an intended travel location. Company A 404 can submit a bid of about five cents to have about a five-second advertisement played. Company B 406 can submit a bid of about seven cents for about a five-second advertisement presentment while Company C 406 can submit a bid of about nine cents to have about a three-second advertisement disclosed.

The choice component 104 can select a bid based on multiple criteria types. For example, a user in the vehicle can prefer coffee from Company B 406 and a record of the preference can be held in a personal profile retained in storage. However, Company B 406 can configure not to be the most cost effective selection—Company C 408 can offer a higher amount of money. The artificial intelligence component 308 of FIG. 3 can place weight on preferences of the user and determine a bid that should be accepted/a detail that should be disclosed to the user.

However, auctions can also be completed through an interactive auction, where different entities place bids with knowledge of other submitted bids. Company A 404, Company B 406, and Company C 408 can place initial bids and a highest bid/bid likely to be appreciated by a user can be disclosed to entities and offers are made to counter-bid; Company B 406 could place another bid that is about 5% higher then a previously disclosed bid. Bidding can complete when the choice component 104 determines a bid has won (e.g., a bid has been selected), a reserve has been met (e.g., monetary reserve, an entity popular with a user has bid, etc.), etc.

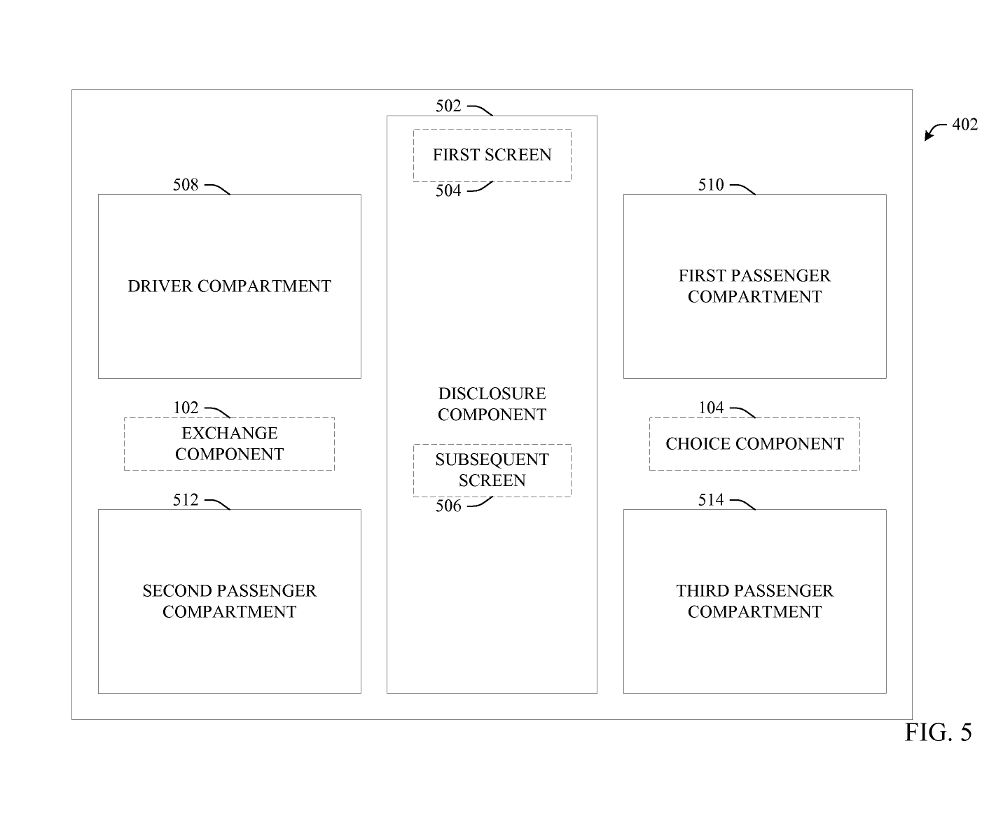

FIG. 5 discloses an example vehicle 402 integrated with a disclosure component 502. The disclosure component 502 presents the detail subset to the user, which allows the user to appreciate a selected detail and/or act upon the detail. A non-exhaustive list of disclosure components include a display screen, touch screen, speaker system, virtual reality environment, Braille production system, printer, etc. In addition, the disclosure component 502 can present information in multiple formats, such as showing a video with audio capabilities.

Furthermore, the disclosure component 502 can include adaptive logic for information presentation. The vehicle 402 can include a video monitor in a center console next to a steering wheel as well as audio speakers. A selected advertisement can last for about thirty seconds while a stop light lasts for about fifteen seconds. In one embodiment, while the automobile is at the stop light, a video plays with sound—when the automobile is in motion the video stops and sound is played, thus causing less distraction to an operator.

The exchange component 102 can engage at least one entity to obtain a bid set that corresponds to a set of details related to an intended travel location of a user. The exchange component 102 can operate as a means for engaging a plurality of entities to obtain a set of bids that corresponds to a set of advertisements that relates to an intended travel location (e.g., destination) of a user. Obtained bids transfer to a choice component 104 that selects a bid subset (e.g., of the bid set), selection of the bid subset (e.g., the bid set, a portion of the bid set, etc.) enables a detail subset (e.g., at least one detail) to be presented to the user. The choice component 104 can function as a means for selecting a bid subset.

According to one embodiment, the disclosure component 502 presents two details associated with the bid subset, a first detail is presented on a first portion (e.g., first screen 504) of the disclosure component 502 and a subsequent detail is presented on a subsequent portion (e.g., subsequent screen 506) of the disclosure component 502. The disclosure component 502 can implement as a means for presenting an advertisement subset to the user, wherein the advertisement subset corresponds to the selected bid subset.

For example, a parent can be seated in a driver compartment 508 and his spouse can be seated in a first passenger compartment 510, both located toward a front of the vehicle 402. An advertisement can be played on the first screen 504 for a fast food restaurant located near an intended destination where the advertisement is for new health foods offered at the restaurant. Children can be seated in a second passenger compartment 512 and a third passenger compartment 514 located at a rear of the vehicle. The children can be presented with an advertisement for the restaurant highlighting a new toy available in a children's meal.

Other configurations can be practiced relating to multiple details disclosed to different parties. A first portion can be a video screen while the second portion is audio speakers. Moreover, the first detail and the second detail can be presented simultaneously or in a staggered manner. In addition, details can be tailored for different individuals in a vehicle (e.g., passengers have their own portions). Operation of the disclosure component 502 can be taken out of a vehicle context—for instance, different details can be presented on different mediums located in a common location (e.g., a cinema sound system, where different theaters are presented information based on estimated routes to a parking lot, such as disclosing nearest bathrooms).

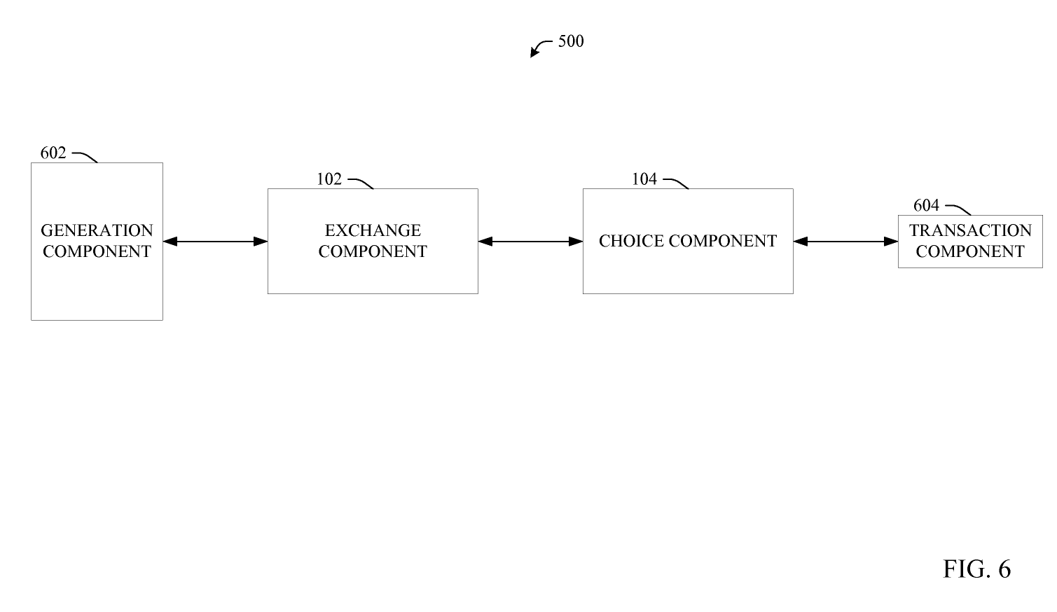

FIG. 6 discloses an example system 600 for conducting a detail disclosure auction in conjunction with generating a route and/or performing a fiscal transaction. A generation component 602 constructs a route to an intended travel location. Various techniques can be used to create a route to an intended travel destination as well as several travel waypoints. A user can enter specific data as to roads to travel and a visual route can be created by the generation component 602. The generation component 602 can collect a starting point and intended destination and a route can be constructed along the route. Moreover, the generation component 602 can create a route automatically—for instance, an inference can be made on an intended destination of a user and a route is created based upon the inference (e.g., through artificial intelligence techniques). In an example, at about 5 p.m. on a Thursday, a route can be generated taking a person from an office to a grocery store and from the grocery store to a residence, where the route is based upon previous actions of the user and/or contextual information (e.g., contexts of a user refrigerator). The generation component 602 can identify locations along the generated route or another route and recognize entities that have a relative high likelihood of producing a bid. Recognized entity names, characteristics, etc., can transfer to an exchange component 102. The generation component 602 can operate as a means for generating a route to the intended travel location.

The exchange component 102 can engage at least one entity to obtain a bid set that corresponds to a set of details related to an intended travel location of a user. Obtained bids transfer to a choice component 104 that selects a bid subset (e.g., of the bid set), selection of the bid subset (e.g., the bid set, a portion of the bid set, etc.) enables a detail subset to be presented to the user. The detail subset presented to the user is commonly an advertisement and the intended travel location is many times an intended travel destination.

A transaction component 604 performs a fiscal operation concerning bid subset selection. Commonly a bid is constructed in such a manner that one party pays money to at least one other party—however, it is to be appreciated that money does not have to change hands. For example, a coupon can transfer instead of money or multiple choices can be presented, such as about one dollar cash or about two dollars worth of coupons. The transaction component 604 performs a transfer between different parties in various manners, such as modifying entries in digital monetary accounts. According to one embodiment, an entity proposing a bid pays a fee and a user has the fee credited to a checking account. However, other configurations can be practiced; the entity can be a subsidiary and a parent company pays the fee while a portion of the fee is received by the user while a portion of the fee is received by a company operating the choice component 104. The transaction component 604 can implement as a means for performing a fiscal operation in relation to engaging the plurality of entities, selecting the bid subset, presenting the advertisement subset to the user, or a combination thereof.

In addition, the transaction component 604 can perform fiscal operations concerning bid subset selection that relates to providing feedback to a bidding party concerning an advertisement. For instance, the bidding party can include a coupon code to a user; when the user purchases an item, the bidding party can ascertain effectiveness of an advertisement disclosed with the coupon code. In another embodiment, the transaction component 604 can disclose metadata to a bidding entity on effectiveness of an advertisement (e.g., such as if a user stopped along a highway exit). Information can be disclosed to a winning bidder as well as to other bidders (e.g., informing a bidder that did not win that a competitors bid was successful, thus creating a likelihood of more revenue for a service host).

Moreover, actions for payment can take place in relation to user response to a commercial detail (e.g., presented with a route). For example, an advertisement can be played that a user should stop at a highway exit for a cup of coffee. If the user takes the exit, buys the cup of coffee, buys a different item, etc., then payments of varying amounts can be made to an advertisement hosting service.

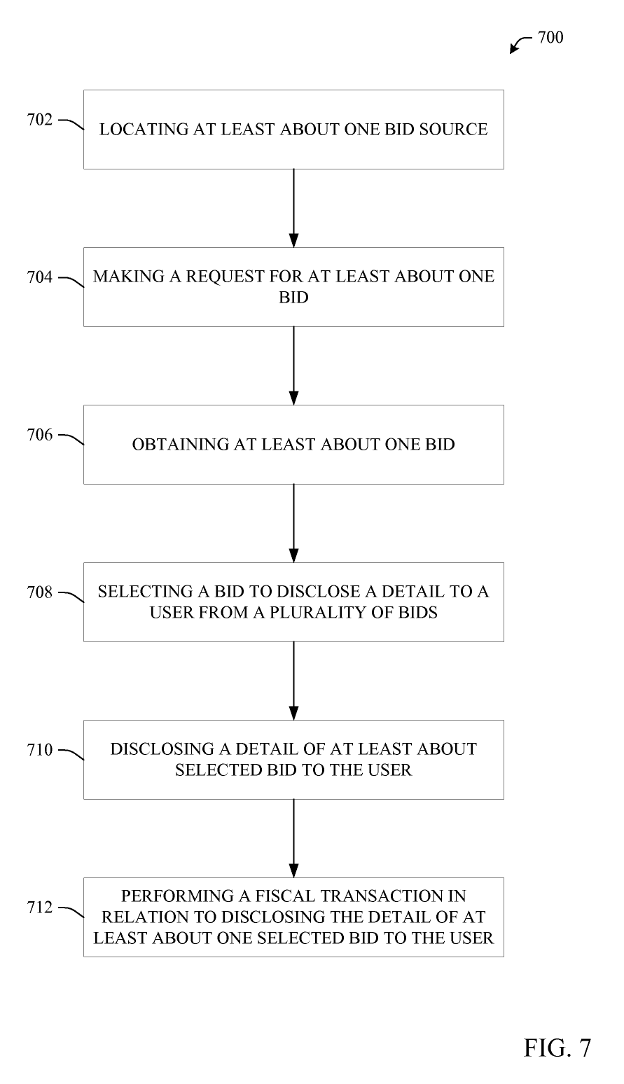

FIG. 7 discloses an example methodology 700 for bid selection and disclosing a detail associated with the selected bid. A search can be performed to locate at least about one bid source at action 702, the bid source can provide a bid to present a detail to a user. Example bid sources include individual establishments, corporate databases, automotive/travel associations, etc. A route is generated, received, etc, and a search can take place of entities that have a relatively high probability of producing a bid based upon the route. A store located about two-tenths of a mile from a route is more likely to produce a bid then a store about twenty miles away. Locating a bid source can take place through database examination, global positioning system, airwave monitoring, etc.

Located potential sources can be contacted with a request for at least about one bid for presentment of a detail to a user at action 704, such as a commercial detail (e.g., advertisement). The request can be accompanied with metadata, such as user characteristics (e.g., age, gender, personal profile information, etc.). Prior to sending a request, the request can be encrypted as well associated metadata—therefore personal information of a user can be encrypted.

Based upon the request, sources can make a determination on if a bid should be produced and parameters related to the bid (e.g., price the entity will pay if the bid is selected). The source can transfer a bid as well as an associated detail to a system operating the methodology 700, and thus at least about one bid is obtained at event 706. Events 704 and 706 can work in conjunction with one another; requests can be sent to about five sources to supply a bid, if a bid is not obtained in about thirty seconds, then about another five requests are made to about five different entities.

A number of different bids can be received and selection of at least one bid can take place at action 708. Selection of a bid enables a detail associated with the bid to be disclosed to a user. Selection can take place according to a number of different criteria, such as based upon financial reward offered for selection of the bid subset, an obligation, a characteristic of a bidder, a characteristic of the user, or a combination thereof. In addition, selection can include several safety factors, such as ensuring that a detail associated with a bid is appropriate (e.g., blocking pornographic content). According to another embodiment, bid selection takes place, a source is notified of a selection, and then a detail is transferred for disclosure to a user. In this embodiment, a safety check can assist to block inappropriate content if desired since the content was not known at a time of bid selection.

A detail associated with a selected bid is disclosed to a user through act 710; common disclosures include visual presentment, playing audio sounds, creating a Braille documents, etc. Various configurations allow multiple details to be associated with one bid (e.g., a bid to pay about two dollars to disclose about three advertisements). Multiple details can be disclosed simultaneously upon different screens of a single vehicle.

A fiscal transaction can take place in relation to disclosing a detail at event 712. For instance, a bid can be accepted and a company can agree to pay a fee to a user for accepting the bid. According to one embodiment, the financial transaction takes place without disclosure of a detail. The fee can be paid upon bid acceptance and an error can take place that the detail is not shown. In addition, the fee can transfer prior to presentation, during presentation, after presentation, etc.

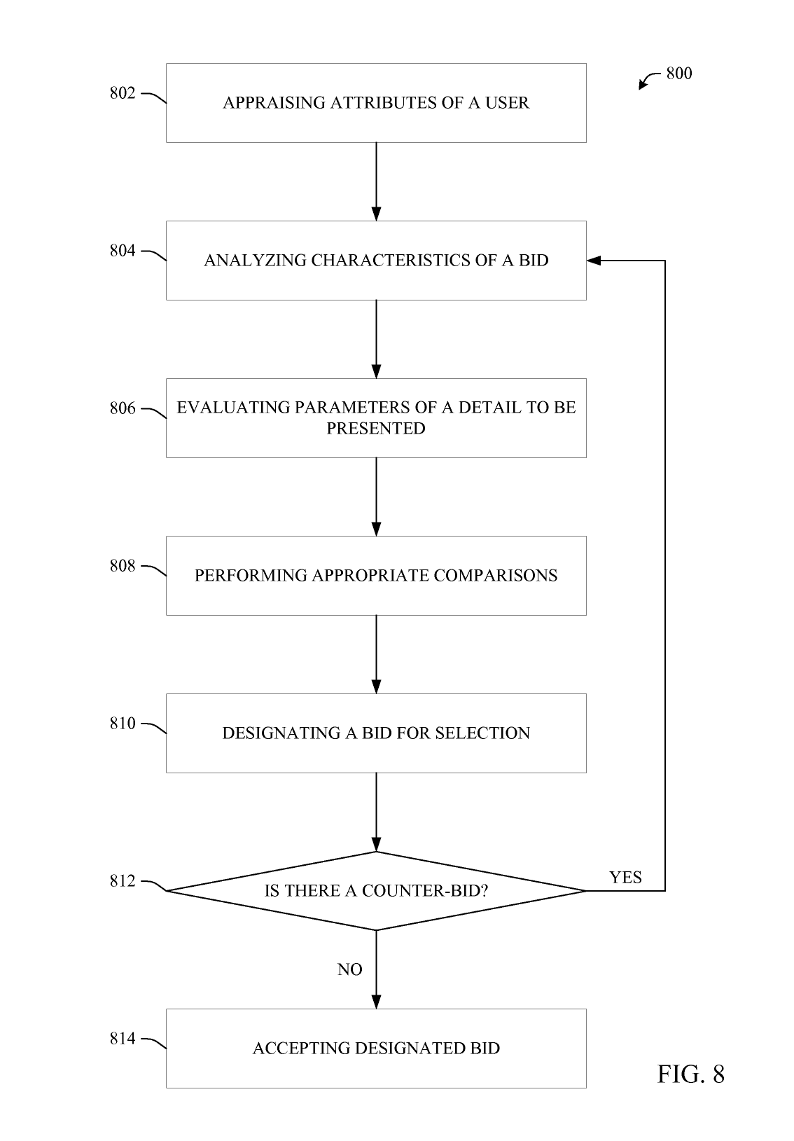

FIG. 8 discloses an example methodology 800 for bid selection in conjunction to with detail disclosure to a user. The methodology 800 can represent practicing event 708 of FIG. 7 in accordance with an aspect of the subject specification. Various attributes are associated with a user, such as age, weight, height, income level, health condition, etc. Appraisal of these attributes takes place at event 802 such that there is a greater likelihood of a presented detail being more relevant. For instance, it can be determined that a user is on a diet, so an advertisement for a health food store will likely be more relevant then for a fast food restaurant.

A bid can have various characteristics and analysis of the characteristics at event 804 enables the methodology 800 to make a suitable decision upon a bid. While a reward being offered can be an important characteristic, other characteristics can become important in decision making. For instance, if there is a contractual obligation to be fulfilled, then a lower bid can be accepted to match the contractual obligation. If a user is socially conscious, then some entities could be favored while others removed due to corporate practices.

In addition to a bid, a detail to be disclosed that is associated with the bid can be evaluated through event 806. Certain parameters of a bid can make the bid more or less desirable for selection. For instance, an individual that is visually impaired can intend on walking from his home to a place of worship. About two bids can be obtained, about one associated with a detail capable of playing sound while another is limited to visual display. Since the individual is visually impaired, the bid that is limited to visual display can be automatically eliminated. It is to be appreciated that aspects of the methodology 800 can be practiced without knowing information related to a detail to be presented.

Based upon results of events 802, 804, and/or 806, comparisons can be made between bids through block 808. Results of the comparisons can be used in designating a bid for selection at action 810. For instance, based upon complex logic, at least about one bid can be selected. Entities can be notified of a bid designated for selection and the entities can be provided an opportunity to place a counter-bid.

A check 812 takes place to determine if a counter-bid is proposed by another entity and/or an entity related to a bid designated for selection (e.g., through use of artificial intelligence techniques). If another bid is proposed, then the methodology 800 can return to event 804 where the counter-bid is analyzed. If there is no counter-bid (e.g., a counter-bid is not submitted in an appropriate amount of time), then the designated bid can be accepted at act 814.

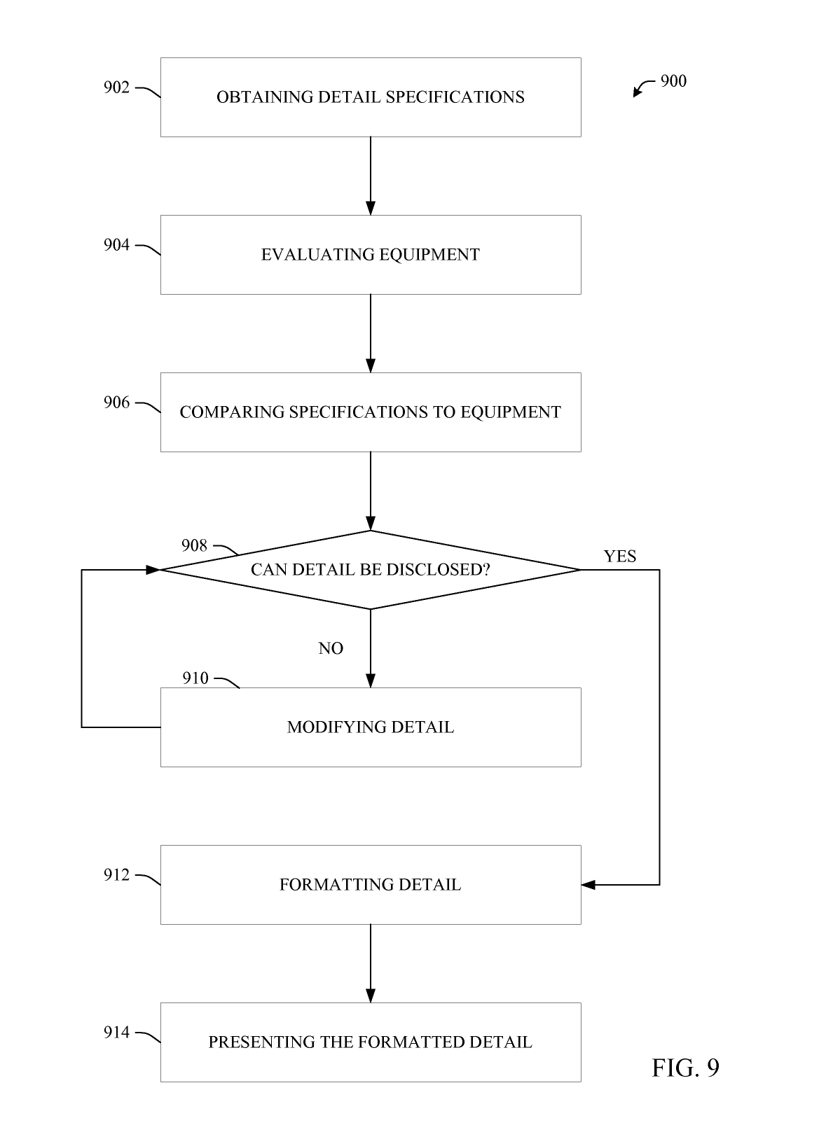

FIG. 9 discloses an example methodology 900 for presenting a detail related to an intended travel location, such as an intended travel destination. The methodology 900 can represent practicing event 710 of FIG. 7 in accordance with an aspect of the subject specification. In an example instance, a detail can be a notice from a police department during an emergency where bidding is between a police department and fire department on which entity has priority to disclose relevant information first.

A detail set for disclosure commonly has several specifications that should be obtained at event 902, such as a medium the detail should be presented upon (e.g., visual, audio, sent, taste, touch, etc.), a length of a detail, etc. Commonly, to disclose a detail, equipment is used to convey the detail to a user. The equipment can be evaluated at action 904 to determine capabilities of the equipment in view of the detail specifications.

A comparison can be made between the detail specification and the equipment at event 906. For instance, if the detail for disclosure is to be an audio file, a determination is made if the equipment has a capability of disclosing an audio sound. A check 908 determines if the detail can be disclosed based upon a result of the comparison and other information, such as available time constraints.

If the detail cannot be displayed, should not be displayed, would be difficult to comprehend if displayed, etc., then the detail can be modified at action 910. If a detail is to be presented in about ten seconds, but an available window is about eight seconds, then the detail can be modified in order to fit within the window. In addition, medium modifications can take place, such as the detail can be an audio file that is automatically transcribed into text.

The methodology 900 can return to check 908 to determine if the detail in modified form can be disclosed. While the methodology 900 discloses a continuous loop of modification and checking, other configurations can be practiced. If the detail cannot be modified in a manner to make the detail in a condition for disclosure, then a request can be made for a new detail. However, the methodology 900 can terminate if an appropriate modification cannot take place and a different bid can be accepted or detail disclosure can be cancelled.

The detail can be formatted to comply with equipment available for disclosure, situational context, etc. A bid can be accepted for an entity operating out of a worldwide headquarters that operates in the English language. If a user is not fluent in English and speaks Arabic as an everyday language, then action 910 can translate the detail from English to Arabic. Other example formatting changes include font size, color/black-and-white, etc. The formatted detail can be supplied to the equipment and presented at event 914

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

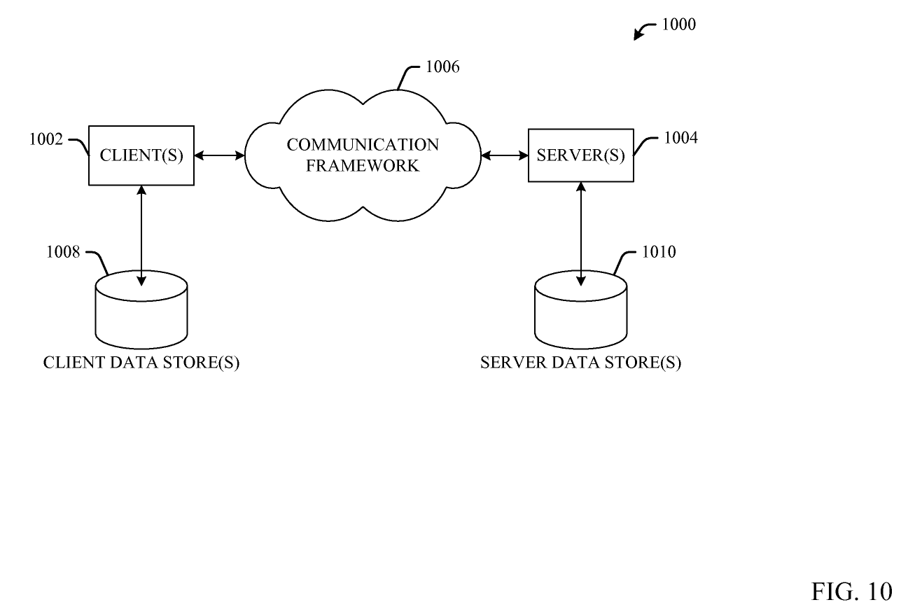

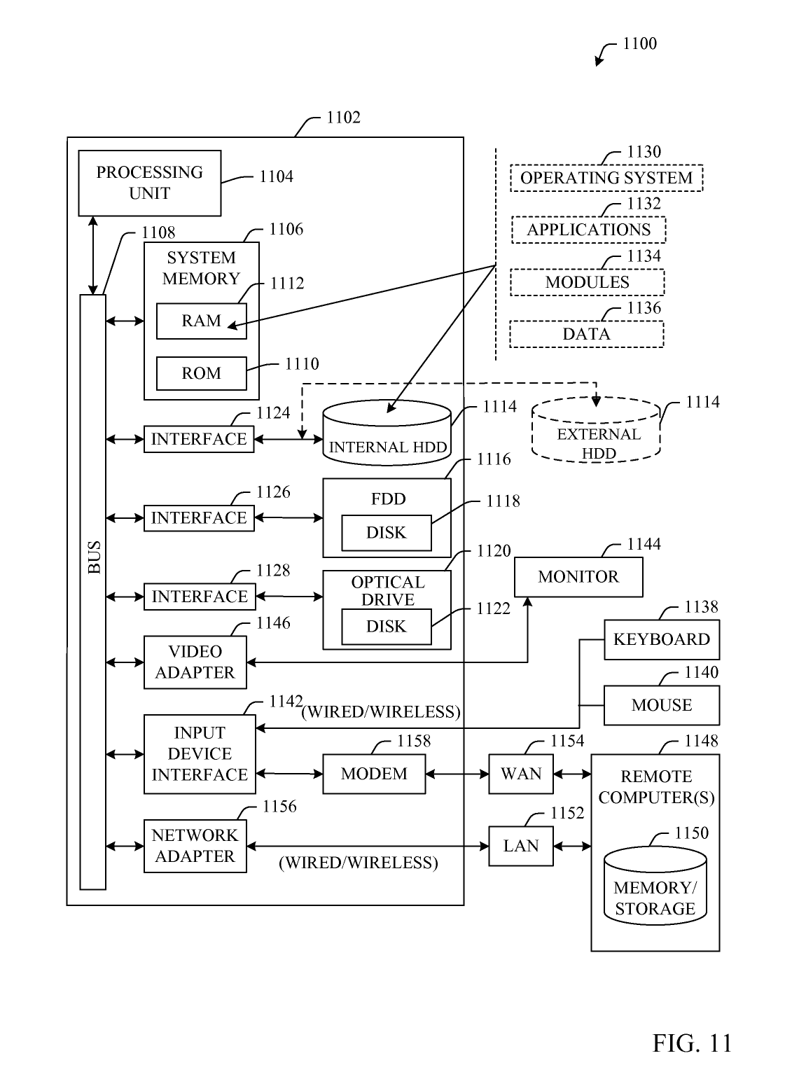

In order to provide a context for the various aspects of the disclosed subject matter, FIGS. 10 and 11 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 10, there is illustrated a schematic block diagram of a computing environment 1000 in accordance with the subject specification. The system 1000 includes one or more client(s) 1002. The client(s) 1002 can be hardware and/or software (e.g., threads, processes, computing devices). The client(s) 1002 can house cookie(s) and/or associated contextual information by employing the specification, for example.

The system 1000 also includes one or more server(s) 1004. The server(s) 1004 can also be hardware and/or software (e.g., threads, processes, computing devices). The servers 1004 can house threads to perform transformations by employing the specification, for example. One possible communication between a client 1002 and a server 1004 can be in the form of a data packet adapted to be transmitted between two or more computer processes. The data packet can include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

Referring now to FIG. 11, there is illustrated a block diagram of a computer operable to execute the disclosed architecture. In order to provide additional context for various aspects of the subject specification, FIG. 11 and the following discussion are intended to provide a brief, general description of a suitable computing environment 1100 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 11, the example environment 1100 for implementing various aspects of the specification includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 can also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the specification can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) can include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 can operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 is connected to the local network 1152 through a wired and/or wireless communication network interface or adapter 1156. The adapter 1156 can facilitate wired or wireless communication to the LAN 1152, which can also include a wireless access point disposed thereon for communicating with the wireless adapter 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are example and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The aforementioned systems have been described with respect to interaction between several components. It should be appreciated that such systems and components can include those components or sub-components specified therein, some of the specified components or sub-components, and/or additional components. Sub-components can also be implemented as components communicatively coupled to other components rather than included within parent components. Additionally, it should be noted that one or more components could be combined into a single component providing aggregate functionality. The components could also interact with one or more other components not specifically described herein but known by those of skill in the art.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an exchange component that engages at least one entity to obtain a bid set that corresponds to a set of details related to an intended travel location of a user; and
a choice component that selects a bid subset, selection of the bid subset enables a detail subset to be presented to the user.

2. The system of claim 1, wherein the selection is based upon financial reward offered for selection of the bid subset, an obligation, a characteristic of a bidder, a characteristic of the user, or a combination thereof.

3. The system of claim 1, wherein the detail subset presented to the user is an advertisement or the intended travel location is an intended travel destination.

4. The system of claim 1, further comprising a disclosure component that presents the detail subset to the user.

5. The system of claim 4, the disclosure component presents two details associated with the bid subset, a first detail is presented on a first portion of the disclosure component and a subsequent detail is presented on a subsequent portion of the disclosure component.

6. The system of claim 1, further comprising an artificial intelligence component that makes at least one inference or at least one determination in relation to bid selection.

7. The system of claim 1, further comprising a transaction component that performs a fiscal operation with regard to bid subset selection.

8. The system of claim 1, further comprising an evaluation component that analyzes the bid set, bid subset selection is based at least in part upon analysis of the bid set.

9. The system of claim 1, further comprising a generation component that constructs a route to the intended travel location.

10. A method, comprising:
selecting a bid to disclose a detail to a user from a plurality of bids; and
disclosing a detail of at least about one selected bid to the user, the disclosed detail is associated with an intended travel location.

11. The method of claim 10, further comprising obtaining at least about one bid, wherein selection takes place upon at least about one obtained bid.

12. The method of claim 11, further comprising making a request for at least about one bid, wherein obtainment takes place as a response of the request.

13. The method of claim 10, further comprising performing a fiscal transaction in relation to disclosing the detail of at least one selected bid to the user.

14. The method of claim 10, further comprising locating at least about one bid source, the located bid source produces the selected bid.

15. The method of claim 10, selecting a bid to disclose a detail to a user from a plurality of bids is performed through artificial intelligence techniques.

16. A system, comprising:
means for engaging a plurality of entities to obtain a set of bids that corresponds to a set of advertisements that relates to an intended travel location of a user;
means for selecting a bid subset; and
means for presenting an advertisement subset to the user, wherein the advertisement subset corresponds to the selected bid subset.

17. The system of claim 16, further comprising means for generating a route to the intended travel location.

18. The system of claim 16, further comprising means for performing a fiscal operation in relation to engaging the plurality of entities, selecting the bid subset, presenting the advertisement subset to the user, or a combination thereof.

19. The system of claim 16, further comprising means for locating entities, located entities are engaged for bid obtainment.

20. The system of claim 19, further comprising means for determining location types that are to produce the set of bids.
